(19) United States
(12) Patent Application Publication
(10) Pub. No.: US 2014/0240076 A1
(43) Pub. Date: Aug. 28, 2014

(54) SECONDARY TRANSFORMER UNIT FOR PLACING ON A VEHICLE WITH AN ELECTRIC DRIVE AND VEHICLE WITH AN ELECTRIC DRIVE

(71) Applicant: Audi AG, Ingolstadt (DE)

(72) Inventors: Björn Elias, Hepberg (DE); Anca Ebner, Vohburg (DE); Christian Ohlen, Gaimersheim (DE)

(21) Appl. No.: 14/352,635

(22) PCT Filed: Oct. 11, 2012
(86) PCT No.: PCT/EP2012/004264

§ 371 Date: Apr. 17, 2014

(30) Foreign Application Priority Data
Oct. 18, 2011 (DE) 10 2011 116 246.5

(51) Int. Cl. H01F 27/24

(52) U.S. Cl. CPC H01F 27/24
USPC 336/221

(57) ABSTRACT

A secondary transformer unit for placement on a vehicle with an electric drive includes at least one secondary core having a top side and a bottom side which define the secondary core in the z-direction; at least one secondary coil arranged on the secondary core, wherein the secondary core has at least one target deformation means which extends essentially in the z direction between the top side and the bottom side.

The invention relates to a secondary transformer unit for placement on a vehicle with an electric drive according to the preamble of claim 1 and to a vehicle with an electric drive.

Motor vehicles with an electric drive, such as hybrid cars and pure electric cars, which have traction batteries for supplying electric power to an electric motor, are known in the art. These conventional motor vehicles are equipped with a system for inductive energy transfer, which also allows a frequent recharging of the batteries with ease of use. This system works like a transformer and includes a primary transformer unit installed on the infrastructure side, for example on the rear wall of a garage, and a secondary transformer unit that is integrated at the front of the motor vehicle behind the front license plate.

The document DE 10 2009 023 409 A1 relates to a system for electric power transmission and forms the basis for the preamble of claim 1. This document discloses a secondary transformer unit or secondary transformer which is mounted at the bow or at the front of an electric vehicle and includes a U-shaped half transformer core and a coil winding wound thereon at an oblique angle. This secondary transformer unit is mounted at the front bumper of the electric vehicle, and the front license plate of the electric vehicle is mounted on the secondary transformer unit.

Since this conventional secondary transformer unit is mounted at the bow of the vehicle, it must be integrated in an area of the vehicle that has a high influence on the crash behavior in accidents involving pedestrians. In particular, the front of the vehicle becomes harder due to the additionally installed components, in particular the half-transformer core usually composed of magnetic steel sheets or ferrite; however, a well-defined and smooth vehicle front is necessary to minimize the risk of injury to pedestrians. Since the conventional secondary transformer unit is mounted at the front bumper behind the front license plate, less space remains available for deformation elements made of foam arranged between the bumper and the passenger compartment, requiring a reduction in their thickness, i.e. its extent in the direction of travel. This leads to a further increase of the hardness of the vehicle front.

It is the object of the invention to improve a secondary transformer unit according to the preamble of claim 1 and a vehicle with an electric drive with such a secondary transformer unit with respect to crash behavior in accidents involving pedestrians.

This object is solved by a secondary transformer unit according to claim 1 and an electric vehicle according to claim 10. Further embodiments are described in the dependent claims.

According to a first aspect, the invention proposes a secondary transformer unit for attachment to a vehicle having an electric drive, including
at least one secondary core with a top side and a bottom side opposite the top side, which delimit the secondary core in a first direction; and
at least one secondary coil arranged on the secondary core,
   wherein
the secondary core has at least one target deformation means extending in the first direction between the top side and the bottom side.

Because a deformation of the typically hard secondary core occurs on the target deformation means in the event of an accident with a pedestrian, the impact energy of the pedestrian can be dissipated in a defined manner. The thickness, i.e. the dimension in the direction of travel, and the shape of the foam deformation elements for protecting pedestrians can be easily optimized so that the best possible positive effect arises in the crash behavior because portions of the secondary core adjacent to the target deformation means distribute the impact forces.

The secondary core may be formed as needed on any number of ways, and is preferably substantially plate-shaped and has for example a width in a y-direction, a height in a z direction and a thickness in an x-direction that is smaller than the width and the height. In this case, the x-direction corresponds to the direction of travel or the longitudinal direction of the vehicle on which the secondary transformer unit is to be mounted, the y-direction corresponds to the transverse direction of this vehicle, and the z-direction corresponds to the vertical direction of this vehicle. Preferably the thickness is less than the height, and the height is less than the width.

Since the elements with a target deformation extend substantially in the z-direction, especially the legs of a pedestrian caught by the front of the vehicle can be protected.

Such substantially plate-shaped secondary core can be easily deformed in a collision in the x-direction and requires little installation space between the bumper and the passenger compartment, so that foam deformation elements to be installed in this area that is important for the frontal crash performance can have a greater thickness, i.e. dimension in the direction of travel.

The target deformation means may be oriented, as required, in any fashion, for example at least partially straight and/or curved and/or angled and/or undulating and/or zigzag-shaped and/or may only be disposed on at least one partial section between the top side and bottom side.

However, the target deformation means extends preferably from the top side to the bottom side, or connects the top side with the bottom side.

This course of the target deformation means enables a particularly easy deformation of the secondary core on impact with an object extending substantially in the z-direction, such as a leg of a pedestrian.

The target deformation means may be formed, as required, in a number of ways and may include, for example, at least one nominal fracture line and/or at least one nominal bending line. The nominal fracture line and/or the nominal bending line preferably have preferably at least one perforation line and/or at least one groove.

Both the perforation line and the groove cause weakening of the material and are constructed so the material can break along the corresponding nominal fracture line or can be bent along the nominal bending line.

Alternatively or additionally, the target deformation means may have at least one, in particular elongate, connecting element that is softer and/or more elastic than the adjoining sections of the secondary core.

This connecting element thus allows a relative movement, in particular a folding movement, between the adjacent sections of the secondary core, for example similar to a hinge. It may include, as required, the aforementioned nominal fracture lines and/or nominal bending lines.

The material of the connecting element can be arbitrarily selected as required and preferably contains a soft magnetic material.

Thus, the connecting element may be produced, for example, from a mixture of a plastic material, such as PE or PP, or a rubber material and a powdery soft magnetic material, such as ferrite powder, in particular by injection molding.

Alternatively or additionally, it may be provided that
the connecting element has at least one wire and/or at least one film and/or at least one grid and/or at least one network;
the wire and/or foil and/or the grid and/or the network are connected to the sections of the secondary core adjacent to the connecting element.

The materials for the wire, the film, the grid and the network may be selected arbitrarily according to need and contain, for example, at least one metal and/or a rubber material and/or at least one plastic material and/or carbon and/or at least one silicone and/or at least one glass and/or at least one ceramic and/or are preferably magnetically soft.

It may be provided that the target deformation means divides the secondary core in the y-direction into sections of equal width.

These sections are preferably constructed identically, allowing the secondary core to be manufactured easily and inexpensively.

It may be provided that the edges of the sections of the secondary core connected by the target deformation means are rounded or chamfered.

This reduces the risk of injury from individual sections that may have become detached in a collision.

According to a second aspect of the invention, a vehicle with an electric drive is proposed, which includes at least one of the proposed secondary transformer units.

It may be provided that one of the secondary transformer units is arranged on the front of the vehicle and/or one of the secondary transformer units is arranged at the back of the vehicle and/or one of the secondary transformer units is arranged at the left side of the vehicle and/or one of the secondary transformer units is arranged at the right side of the vehicle.

Each proposed vehicle may further include a front license plate arranged in front of a secondary transformer unit at the front in the direction of travel, and/or a rear license plate arranged in the direction of travel behind a secondary transformer unit mounted at the rear.

The discussions relating to one aspect of the invention, in particular to individual features of this aspect, apply mutatis mutandis similarly for the other aspects of the invention.

Embodiments of the invention will now be described in more detail with reference to the accompanying drawings. The resulting individual features, however, are not limited to the individual embodiments, but may be combined with several of the above-described individual features and/or with features of other embodiments. The details in the drawings are to be understood as only illustrative, but not as limiting. The reference symbols included in the claims are not intended to limit the scope of the invention in any way, but merely refer to the embodiments shown in the drawings.

The drawings show in:

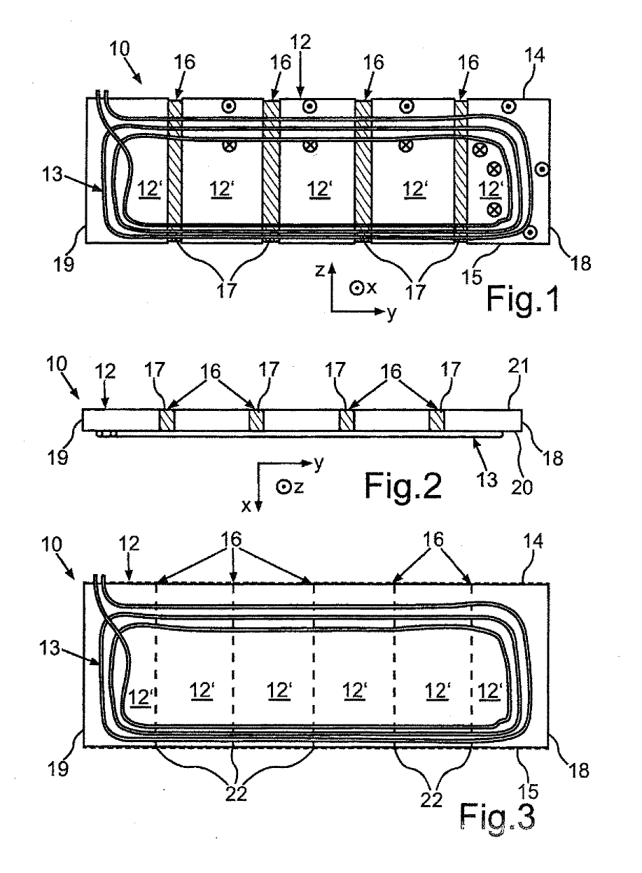

FIG. 1 a front view of a secondary transformer unit in a first embodiment, which can be arranged at a front of a vehicle having an electric drive;

FIG. 2 the plan view of FIG. 1;

FIG. 3 a front view of a secondary transformer unit in a second embodiment; and

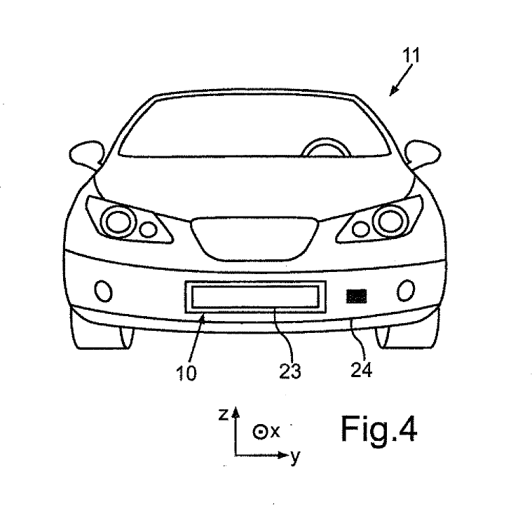

FIG. 4 a front view of a vehicle with an electric drive in a preferred embodiment.

FIGS. 1 and 2 show schematically a first embodiment of a secondary transformer unit 10 according to the invention for attachment to a vehicle limit an electric drive (FIG. 4). This secondary transformer unit 10 includes a secondary core 12 and a secondary coil 13 arranged on the secondary core 12. The secondary core 12 has a top side 14 and a bottom side 15 which delimit the secondary core 12 in a z-direction, which points in FIG. 1 toward the top and in FIG. 2 toward the front of the drawing plane and which corresponds to the vertical direction of the vehicle.

In this first embodiment, the secondary core 12 has four oblong or elongated or bar-shaped target deformation means 16, each extending in the z direction from the top side 14 to the bottom side 15 and being arranged so as to divide the secondary core 12 into five sections 12′ of equal width in a y-direction, which points in FIGS. 1 and 2 to the right and which corresponds to the transverse direction of the vehicle.

In this first embodiment, each target deformation means 16 has a connecting element 17. Each connecting element 17 consists of a material containing rubber and fine ferrite powder uniformly dispersed therein, and is therefore softer and more resilient than the respective adjacent sections 12′ of the secondary core 12, each of which is made of ferrite. Each connecting element 17 was connected by vulcanization of the rubber-ferrite-powder mixture with the two respective adjacent sections 12′.

In this first embodiment of the secondary core 12 is plate-shaped and has a left side 18, a right side 19, a front side 20 and a rear side 21. The left side 18 and right side 19 delimit the secondary core 12 in the y-direction. The front side 19 and rear side 20 delimit the secondary core 12 in an x-direction which points toward the front in the drawing plane in FIG. 1 and downwards in FIG. 2. The x-direction corresponds to the direction of travel or the longitudinal direction of the vehicle 11. In addition, the secondary core 12 has a width in the y direction that corresponds to the distance between the left side 18 and the right side 19, in the z direction a height that corresponds to the distance between the top side 14 and the bottom side 15 and is clearly smaller than the width, and in the x direction a thickness that corresponds to the distance between the front side 20 and the rear side 21 and is significantly less than the height.

In this first embodiment, the secondary coil 13 is arranged in three substantially rectangular turns on the front side 20 of the secondary core 12. An unillustrated primary transformer unit having a primary core and a primary coil arranged on the primary core is configured such that when it is placed at a small distance in front of the front face 20 and an AC current flows through its primary coil, a magnetic field is generated having field lines indicated in FIG. 1 by the circles with a dot and circles with a cross. Field lines enter, for example, the sections 12′ at locations on the front face 20 marked by the circles with a cross and exit the sections 12′ at locations marked by the circles with a dot and extend inside the sections 12′ from the circles with a cross to the circles with a dot. These field lines thus envelop the turns of the secondary coil 13 and induce therein an AC voltage which is supplied to an unillustrated high-voltage onboard electrical system of the vehicle 11 for charging its traction batteries.

FIG. 3 illustrates a secondary transformer unit 10 according to the invention in a second embodiment. This second embodiment is similar to the first embodiment, so in the following only the differences will be described in detail.

In this second embodiment of the secondary core 12 has five target deformation means 16, each having a nominal fracture line 22 in the form of a perforation line. The secondary core 12 is made in one piece and is composed of ferrite, and the nominal fracture lines 22 include perforation openings or through-holes formed in the material of the secondary core 12.

FIG. 4 shows schematically a preferred embodiment of a vehicle 11 according to the invention with an electric drive in the form of a hybrid car. This vehicle 11 includes a secondary transformer unit 10 in the first embodiment, a front license plate 23 and a front bumper 24.

In this preferred embodiment, the secondary transformer unit 10 is arranged at the front of the vehicle 11 and attached with the backside 21 facing rearward in the x-direction to a front side to the front side of bumper 24 facing forward in to the x direction. Also, the license plate 23 is arranged in the x-direction in front of the secondary transformer unit 10 and fastened with its rear side facing rearward opposite to the x-direction to the front face 20 of the secondary core 12. In this case, the license plate 23 is arranged and the turns of the secondary coil 13 are placed on the front side 20 of the secondary core 12 such that the license plate 23 abuts the partial area of the front side enveloped by the secondary coil 13 and the secondary coil 13 surrounds the license plate 21 without touching it.

What is claimed is:

1.-12. (canceled)

13. A secondary transformer unit for attachment to a vehicle having an electric drive, the secondary transformer unit comprising:
at least one secondary core having a top side and a bottom side opposite the top side, which delimit the at least one secondary core in a first direction;
at least one secondary coil arranged on the at least one secondary core; and
at least one target deformation means disposed on the at least one secondary core and extending in the first direction between the top side and the bottom side.

14. The secondary transformer unit of claim 13, wherein the at least one target deformation means extends from the top side to the bottom side.

15. The secondary transformer unit of claim 13, wherein the at least one target deformation means comprises at least one of a nominal fracture line and a nominal bending line.

16. The secondary transformer unit of claim 15, wherein the nominal fracture line or the nominal bending line comprise at least one of a perforation line and a groove.

17. The secondary transformer unit of claim 15, wherein the at least one target deformation means comprises a connecting element which is softer or more elastic, or both, than adjoining sections of the at least one secondary core.

18. The secondary transformer unit of claim 17, wherein the material of the connecting element includes a soft magnetic material.

19. The secondary transformer unit of claim 17, wherein the connecting element comprises a wire connected to the adjoining sections of the at least one secondary core adjacent to the connecting element.

20. The secondary transformer unit of claim 13, wherein the target deformation means divides the at least one secondary core in a y-direction into sections having identical width.

21. The secondary transformer unit of claim 13, wherein sections of the at least one secondary core connected by the target deformation means comprise edges that are rounded or chamfered.

22. A vehicle with an electric drive, the vehicle comprising at least one secondary transformer unit having at least one secondary core having a top side and a bottom side opposite the top side, which delimit the at least one secondary core in a first direction; at least one secondary coil arranged on the at least one secondary core; and at least one target deformation means disposed on the at least one secondary core and extending in the first direction between the top side and the bottom side.

23. The vehicle of claim 22, wherein the at least one secondary transformer unit is arranged at a front section of the vehicle.

24. The vehicle of claim 22, wherein the at least one secondary transformer unit is arranged at a rear section of the vehicle.

25. The vehicle of claim 22, wherein the at least one secondary transformer unit is arranged on a left side of the vehicle.

26. The vehicle of claim 22, wherein the at least one secondary transformer unit is arranged on a right side of the vehicle.

27. The vehicle of claim 22, further comprising a front license plate disposed at a front section of the vehicle and arranged in a direction of travel of the vehicle in front of the at least one secondary transformer unit.

28. The vehicle of claim 22, further comprising a rear license plate disposed at a rear section of the vehicle and arranged in a direction of travel of the vehicle behind the at least one secondary transformer unit.
